(19) United States
(12) Patent Application Publication
(10) Pub. No.: US 2025/0148410 A1
(43) Pub. Date: May 8, 2025

(54) Integrated System for Global Logistics Distribution And Fulfillment Management

(71) Applicant: David A. Jacobson, Rochester, MI (US)

(72) Inventor: David A. Jacobson, Rochester, MI (US)

(21) Appl. No.: 18/387,868

(22) Filed: Nov. 8, 2023

(51) Int. Cl. G06Q 10/0835; G06Q 10/0833; G06Q 10/087

(52) U.S. Cl. CPC G06Q 10/08355; G06Q 10/0833; G06Q 10/087

(57) ABSTRACT

The present disclosure provides a system, method and a computer product for the management of the global logistics. The system comprises a computer program product that is provided to route and optimize the delivery of one or more packages of the logistics, group the one or more packages based on a specific criteria, and track the logistic in a real-time. Further, the system comprises one or more shipping platforms made of an enclosure body and one or more lightweight cargo containers, and one or more self-stacking platform configured within the lightweight container of the one or more shipping platforms.

### TECHNICAL FIELD

The present disclosure relates to a method and system as an end-to-end solution for the global logistics management.

### BACKGROUND

The current logistics and cargo delivery systems face several challenges and issues. Some of the common problems are Inefficiency, Lack of visibility and tracking, Manual processes, Infrastructure limitations, Security risks, Environmental impact, and Last-mile delivery challenges.

The logistics and cargo delivery systems often suffer from inefficiencies, resulting in delays and increased costs. Inadequate coordination between various stakeholders, such as suppliers, carriers, and receivers, can lead to inefficient use of resources and time. Tracking cargo throughout the supply chain can be challenging. Many systems lack real-time visibility, making it difficult to monitor the location, condition, and estimated time of arrival of goods. This lack of visibility can lead to uncertainties, delays, and difficulties in managing inventory.

Several logistics and cargo delivery processes still rely heavily on manual paperwork and time-consuming administrative tasks. These manual processes are prone to errors, can cause delays in processing, and hinder overall efficiency. Further, Traditional logistics and cargo delivery systems heavily rely on fossil fuels, contributing to greenhouse gas emissions and environmental degradation. The carbon footprint associated with transportation and delivery needs to be reduced through the adoption of sustainable practices and alternative energy sources.

Delivering goods to the final destination, especially in urban areas, can be challenging. Factors such as congested traffic, limited parking, and difficulty in accessing certain locations can result in delays and inefficiencies in last-mile delivery.

Therefore, there is a need of a complete system and method for global logistics and cargo management. Further, there is a need of a system that may efficiently route and optimize cargo delivery and real-time track and monitor delivery status and location of each cargo.

### SUMMARY

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter. The “Self stacking platform” herein disclosed refers and to be read at par to patent titled “Self-Stacking Strategically Packed and Collated Enclosure (Space) Platform” ( U.S. Pat. No. 11,427,381 B1) and “Shipping platform” herein disclosed refers and to be read at par to patent titled “Cargo Shipping Platform for Lightweight Cargo Containers” (Application no. U.S. Ser. No. 17/504,574).

The present disclosure discloses a system made of a computer program product and a hardware devices to provide an end-to-end solution for the global logistic problems. Further, the disclosure discloses a method or working of the system and a computer program product. A first aspect of the present disclosure relates to a system for a global logistics management. The system, according to the first aspect, is provided with a computer program product, one or more shipping platform, and one of more self-stacking platform. The computer program product is provided to route and optimize the delivery of one or more packages of the logistics, group the one or more packages based on a specific criteria, and track the logistic in a real-time. The specific criteria include a ZIP code or area code of a delivery location. The one or more shipping platform made of an enclosure body and one or more lightweight cargo containers. The one or more self-stacking platform configured within the lightweight container of the one or more shipping platform.

The computer program product is a computer readable program code that is configured within the processing circuitry of any smart device including the personal computer, laptop, smartphone or dedicated smart device. The computer readable program code causes the computing circuitry to receive inputs from different hardware devices and elements of the system, process the inputs using the program code and provide an output features. The processing circuitry, using the computer program product, is provided to enable placement of the one or more packages of the logistic within the one or more self-stacking platform according to a delivery order.

Further, the processing circuitry is provided to capture the dimensions of each of the one or more packages. The processing circuitry uses the captured dimensions to optimize an internal space and suggests placement of the one or more packages within the one or more self-stacking platform. Further, the processing circuitry suggests the placement of the one or more packages within the one or more self-stacking platform based on an order of the delivery locations.

Further, the processing circuitry is configured to notify a customer of delivery status and probability of delay in delivery in advance.

The one or more shipping platform comprises a pair of a 20 feet lightweight cargo containers. The pair of the 20 feet lightweight cargo containers are enclosed end within the enclosure body of the shipping platform. Therefore, the enclosure body and a pair of enclosed lightweight cargo containers forms a 40 feet shipping platform similar to a conventional shipping containers.

the one or more self-stacking platform are compact platforms that are capable of being stacked one over another and enable placement of the one or more packages of the logistics over the platforms.

The one or more self-stacking platforms comprises a unique identifier QR codes placed on one or more sides. Further, the lightweight container comprises a unique identifier QR codes configured on an inside walls of the lightweight container. Further, the shipping platform comprises the unique identifier QR code configured on a top of the one or more shipping platform.

In another embodiment, the one or more shipping platform and the one or more self-stacking platform may comprise a data embodied electronic tag. The data embodied electronic tag may be a RFID tag or any other dedicated battery operated tags.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1A is a view of a logistic packages placed within the delivery vehicle over a self-stacking platform, according to an aspect of the present disclosure.

FIG. 1B is a view of plurality of package-loaded self-stacking platforms stacked over each other within another delivery vehicle, according to an embodiment of the present disclosure.

FIG. 2A is a view of package-loaded self-stacking platforms configured within the shipping platform placed over a rail wagon, according to an embodiment of the present disclosure.

FIG. 2B is a view of package-loaded self-stacking platforms configured within the shipping platform, according to an embodiment of the present disclosure.

### DETAILED DESCRIPTION OF INVENTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware and or by human operations.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc, read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a”, “an”, and “the” includes plural reference unless the context clearly dictates otherwise. Also, as used in the description herein, the meaning of “in” includes “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and willfully convey the scope of the invention to those ordinary skilled in the art. Moreover, all the statements herein reciting embodiments of the invention, as well as specific examples thereof, are intended to encompass both structural and functional equivalent thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

The present disclosure provides a system which is a combination of a tangible hardware devices or equipment and a computer program product configured within the processing circuitry of at least one of the smart device to create a system that provides an end-to-end solution and management of global logistics. The smart device may be a personal computer, laptop, tablet, smartphone, or any other dedicated smart devices comprising one or more processing circuitry capable of executing the program codes of the computer program product.

According to an aspect, the computer program product when executed by the processing circuitry of the smart device, delivers the function of routing and optimization of the delivery of end-to-end cargo. The processing circuitry, using the computer program product, receives the information of orders of customers from different locations. The processing circuitry then groups the packages according to the orders of customers based on a specific criteria of the order. For instance, the processing circuitry groups the plurality of packages of orders based on the ZIP code or area code of the customer's location.

Further, the processing circuitry request for the dimensions of each of the package. In another embodiment, the processing circuitry using one or more camera, calculates the dimension of each of the package from the grouped plurality of packages based on the ZIP code. Further, the processing circuitry by using the delivery location of each package from the plurality of packages, their dimensions, and dimension of the self-stacking platform, determines and suggest the placement of the packages according to their delivery order. Further, the processing circuitry determines the placement of each of the plurality of packages to cube out the self-stacking platform, thus optimizing the capacity of the platform. The optimized arrangement according to the delivery order enables a user or a delivery personal locate packages arriving the delivery locations, resulting saving in time.

Further, the processing circuitry, based on the locations and ZIP codes for the delivery of grouped packages, determines the delivery order for each of the package. Further, the processing circuitry defines and suggests the best possible delivery route based on the determined delivery order. Further, the processing circuitry receives the information of delivery of each package in real-time and determines any possibility of delay in delivery of any package. Further, the processing circuitry notifies the customer of any delay in advance based on the determined possibility of the delay.

According to an embodiment, the system further uses one or more unique identifier codes configured over the one or more self-stacking platform and one or more shipping platform to monitor and track their real-time location to determine the delivery status.

The system comprises one or more unique identifier QR codes but not limited to so said be placed on each of the one or more sides of the self-stacking platform.

In one embodiment, the system further uses one or more unique identifier codes configured within the lightweight cargo containers of the shipping platform. The one or more unique identifier codes are configured over an internal walls of the lightweight cargo containers.

Further, the shipping platform may comprises a unique identifier QR code but not limiting to so said be configured over a top of the shipping platform.

In another embodiment, the self-stacking platform and the shipping platform may comprise an electronic tags embodying data associated with the respective self-stacking platform and the shipping platform. The electronic tag may be a RFID tag or any other dedicated battery operated tags.

Further, the system of present invention is capable of being used to route and optimize the international cargo shipment and global logistics management.

According to an embodiment, the system further comprises one or more self-stacking platform as a part of the present system and as a platform for the placement and holding the packages of logistics or cargo.

The self-stacking platform addresses the need of a reusable shipping platform that provides an alternative to the wooden or plastic pallets currently being used in logistic market. The self-stacking platform are foldable when required and stackable upon each other thus eliminating the need for expensive permanent racks that take up unnecessary floor space in the warehouses/fulfillment buildings, wherein when loaded with packages can be stacked to provide a stud built in racking within the warehouse.

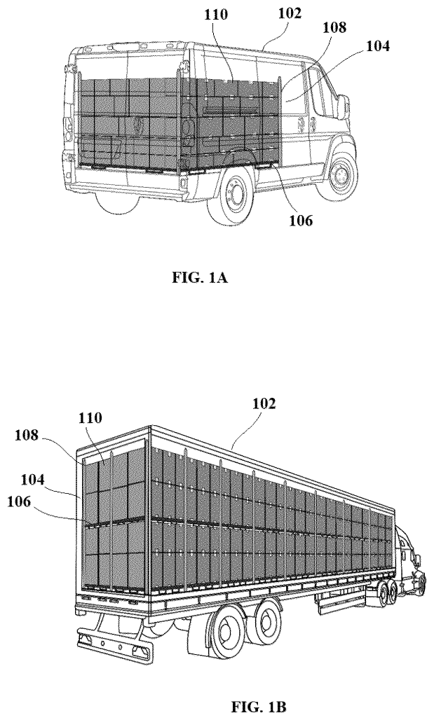

FIG. 1A is a view of a cargo packages 110 placed within the delivery vehicle 102 over a self-stacking platform 104, according to an aspect of the present disclosure.

Referring to the FIG. 1, the self-stacking platform 104 comprises a steel frame or base 106 with expandable sides having steel plates with holes to allow the base to be enlarged or reduced when needed and with four square sockets or corner supports welded on all four corners of the base, four uprights 108.

According to one embodiment, the self-stacking platform is provided with an inverse pyramid shaped female pocket at the top and a male pyramid shaped target at the bottom of each upright which is capable of being inserted and locked within the four square corner support of the base therefore making it a rigid and stable enclosure module whether used as its own shipping module or when the self-stacking platform is inserted into it for the purposes of offering the stability of shipment and stackable feature when in storage.

Further, a fork lift slots on all four sides of the base is provided within the platform 104 to allow lifting of the platform 104 using conventional fork lift and a plurality of shields above the fork lift slots on all the sides to prevent damage to the product or carton present over the platform in the events when fork lift misses the fork lift slot.

By utilizing the present self-stacking platform, the system enables sorting and loading of an online orders by zip code and placement of the sorted order onto a dedicated self-stacking platform for that zip code destination. All zip coded platforms for a specific metropolitan area will ship on a truck to the metropolitan area transfer hub, as shown in the FIG. 1B. Since the packages were sorted, routed and packed already, the self-stacking platform can be placed inside the delivery vehicle at the metropolitan transfer hub for final delivery, as shown in the FIG. 1A. The self-stacking platform therefore reduces the number of human touches, ships all truckloads at near 100% capacity, and streamlines the logistics and reduces the time and expense of getting online orders to the customers for final delivery while allowing safe double stacking with zero to minimal damage to the bottom level stacks or packages by locking the stacking units together.

According to an embodiment, the system further comprises one or more shipping platform made of an enclosure body or frame and one or more lightweight cargo containers.

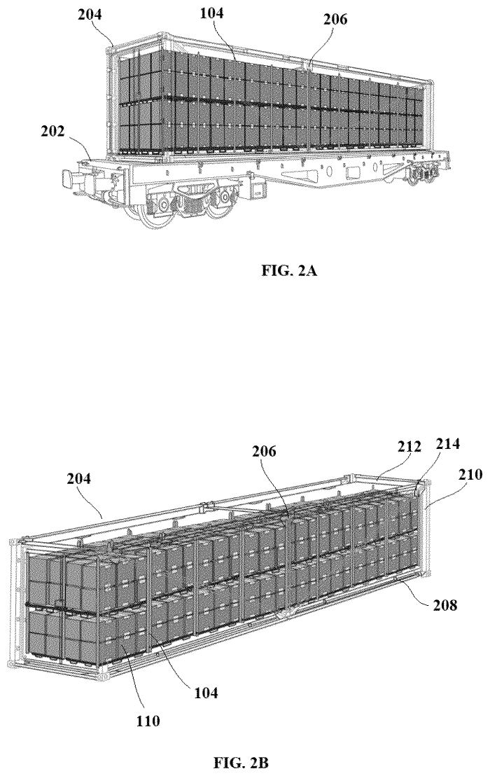

FIG. 2A is a view of package-loaded self-stacking platforms 104 configured within the shipping platform 204 placed over a rail wagon 202, according to an embodiment of the present disclosure. FIG. 2B is a view of package-loaded self-stacking platforms 104 configured within the shipping platform 204, according to an embodiment of the present disclosure.

Referring to the FIG. 2A and FIG. 2B, the shipping platform 204 is made of an enclosure to enclose the lightweight cargo container forming a shipping platform 204 that may serve as an alternative to the existing steel containers which are being used in ocean-going shipping business. The shipping platform of present invention is an enclosure for removable placement of lightweight container modules of present invention that may store and ship the e-commerce or any other cargo in ocean going trips.

According to one embodiment, the cargo shipping platform 204 of present invention is a hinged and gated opening system to allow light-weight container modules to be lifted into the lightweight cargo containers by a common forklift available at all ports. The side openable hinged and gated system uses diagonal steel gate arms 214 hinged on both sides of the platform 204 to secure the shipping platform lightweight cargo containers once placed inside. The side hinged and gated structure or arm 214 of present platform is provided to enclose and accommodate lightweight cargo container modules which serves as a low-weight alternative to the conventional plated steel containers weighing nearly 10,000 pounds when empty.

According to one embodiment, the cargo shipping platform is made of four corner uprights 210 connected with plurality of horizontal long members 211 that forms the length of the lightweight cargo containers and plurality of short members 212 connected perpendicular to the long members connecting at the corners of the uprights 210 to form a width of the present cargo shipping platform 204.

Each of four top corner nodes have standard connection caps recognized as the standard in the container manufacturing industry for lifting containers with cranes. Each four bottom corner have a standard stacking cap which connects corner uprights, long members and short members.

Further, the enclosure body of the cargo shipping platform 204 comprises a central upright 206 to divide the container to secure and hold two 20 feet lightweight cargo containers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

Similarly, structures and functionality presented as a single component may be implemented as separate components. These and other variations, modifications, additions, and improvements fall within the scope of the subject matter herein. In addition, the term “each” used in the specification does not imply that every or all elements in a group need to fit the description associated with the term “each”. For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that are issued on an application based hereon. Accordingly, the disclosure of the embodiments is intended to be illustrative, but not limiting, of the scope of the patent rights.

I claim:

1. A system for a global logistics management, comprising:
processing circuitry comprising a computer program product that causes the processing circuitry to,
route and optimize the delivery of one or more packages of the logistics,
group the one or more packages based on a specific criteria, and
track the logistic in a real-time,
one or more shipping platform made of an enclosure body and one or more lightweight cargo containers; and
one or more self-stacking platform configured within the lightweight container of the one or more shipping platform.

2. The system of claim 1, wherein the specific criteria includes a ZIP code of a delivery location.

3. The system of claim 1, wherein the processing circuitry is provided to enable placement of the one or more packages of the logistic within the one or more self-stacking platform according to a delivery order.

4. The system of claim 3, wherein the processing circuitry is further provided to capture the dimensions of each of the one or more packages.

5. The system of claim 4, wherein the processing circuitry uses the captured dimensions to optimize an internal space and suggests placement of the one or more packages within the one or more self-stacking platform.

6. The system of claim 5, wherein the processing circuitry further suggests the placement of the one or more packages within the one or more self-stacking platform based on an order of the delivery locations.

7. The system of claim 1, wherein the processing circuitry is further configured to notify a customer of delivery status and probability of delay in delivery in advance.

8. The system of claim 1, wherein the one or more self-stacking platforms comprises a unique identifier codes placed on one or more sides.

9. The system of claim 8, wherein the lightweight container further comprises a unique identifier codes configured on an inside walls of the lightweight container.

10. The system of claim 9, wherein the one or more shipping platform further comprises the unique identifier code configured on a top of the one or more shipping platform.

11. The system of claim 10, wherein the unique identifier code may be a QR code, UPC code, Barcode, or any other machine readable code.

12. The system of claim 1, wherein the one or more shipping platform and the one or more self-stacking platform may comprise a data embodied electronic tag.

13. The system of claim 12, wherein the data embodied electronic tag may be a RFID tag or any other dedicated battery operated tags.

14. The system of claim 1, wherein the processing circuitry is further configured to enable the access of real time tracking of the delivery of the one or more packages of the logistics.

15. The system of claim 1, wherein each of the one or more shipping platform comprises a pair of a 20 feet lightweight cargo containers.

16. The system of claim 15, wherein the pair of the 20 feet lightweight cargo containers are enclosed end to end within the enclosure body of the shipping platform.

17. The system of claim 16, wherein the enclosure body and a pair of enclosed lightweight cargo containers forms a 40 feet shipping platform similar to a conventional shipping containers.

18. The system of claim 1, wherein the one or more self-stacking platform are compact platforms that are capable of being stacked one over another.
